(19) United States
(12) Patent Application Publication
(10) Pub. No.: US 2007/0019843 A1
(43) Pub. Date: Jan. 25, 2007

(54) Wireless peripheral device having a sweep-type fingerprint sensing chip

(75) Inventor: Bruce C.S. Chou, Hsin Chu (TW)

Correspondence Address: BIRCH STEWART KOLASCH & BIRCH, PO BOX 747, FALLS CHURCH, VA, 22040-0747, US

(73) Assignee: LIGHTUNING TECH. INC.

(21) Appl. No.: 11/488,602

(22) Filed: Jul. 19, 2006

(30) Foreign Application Priority Data
Jul. 21, 2005 (TW) 094124620

(51) Int. Cl. G06K 9/00

(52) U.S. Cl. 382/124; 340/5.53

(57) ABSTRACT

A wireless peripheral device includes a receiving module, a peripheral device body and a sweep-type fingerprint sensing chip. The receiving module is coupled to a host system through a cable. The body communicates with the receiving module in a wireless manner. The sweep-type fingerprint sensing chip disposed on the body senses a plurality of fingerprint fragment images to obtain a plurality of analog fingerprint fragment signals as a finger is sweeping over it, processes the analog fingerprint fragment signals into non-overlapped fragment images, and outputs the fragment images to the receiving module through an emitter and a receiver. Then, the host system receives and assembles the fragment images into a complete fingerprint image in a manner of stacking the fragment images side by side, compares the complete fingerprint image with a reference fingerprint image, and then enables at least one application program in the host system after the comparison passes.

### BACKGROUND OF THE INVENTION

1. Field of the Invention

The invention relates to a wireless peripheral device, such as a mouse and a keyboard, having a sweep-type fingerprint sensing chip for sensing and transferring fingerprint fragment images to a computer for performing the fingerprint image comparison, and at least one specific application program in the computer or a function of the wireless peripheral device cannot be enabled until the comparison passes. The invention also correlates to the patent applications to the inventor: (a) U.S. patent application Ser. No. 10/998,722 (US20050144464A1), filed on Nov. 30, 2004, and entitled “MEMORY STORAGE DEVICE WITH A FINGERPRINT SENSOR AND METHOD FOR PROTECTING THE DATA THEREIN”; (b) U.S. patent application Ser. No. 10/403,052 (US20030190061A1), filed on Apr. 1, 2003, entitled “CAPACITIVE FINGERPRINT SENSOR”; (c) U.S. patent application Ser. No. 10/434,833 (US20030215976A1), filed on May 13, 2003, entitled “PRESSURE TYPE FINGERPRINT SENSOR FABRICATION METHOD”; (d) U.S. patent application Ser. No. 10/414,214 (US20040208345A1), filed on Apr. 16, 2003, and entitled “THERMOELECTRIC SENSOR FOR FINGERPRINT THERMAL IMAGING”; (e) U.S. patent application Ser. No. 10/638,371 (US20040046574A1), filed on Aug. 12, 2003, and entitled “CAPACITIVE MICRO PRESSURE SENSING MEMBER AND FINGERPRINT SENSOR USING THE SAME”; (f) Taiwan Patent Application No. 090112023, filed on May 17, 2001, and entitled “CAPACITIVE PRESSURE MICROSENSOR AND METHOD FOR MANUFACTURING THE SAME AND DETECTING SIGNALS OF THE SAME”, now issued as Invention Patent Number 182652; (g) U.S. patent application Ser. No. 10/441,022, filed on May 20, 2003, and entitled “SWEEP-TYPE FINGERPRINT SENSOR MODULE AND A SENSING METHOD THEREFOR”; (h) U.S. patent application Ser. No. 10/849,775 (US20040238647A1), filed on May 21, 2004, and entitled “CARD DEVICE WITH A SWEEP-TYPE FINGERPRINT SENSOR”; and (i) U.S. patent application Ser. No. 11/376,179 filed on Mar. 16, 2006, and entitled “LINEAR IMAGE SENSING DEVICE WITH IMAGE MATCHING FUNCTION AND PROCESSING METHOD THEREFOR”.

2. Description of the Related Art

There are many known fingerprint authentication techniques. The use of an ink pad and the direct transfer of ink by the thumb or finger from the ink pad to a recording card is the standard way of making this identification. Then, an optical scanner scans the recording card to get an image, which is then compared to fingerprint images or templates in the computer database. However, the most serious drawback of the above-mentioned method is that the fingerprint identification cannot be processed in real-time, and thus cannot satisfy the requirement of real-time authentication, such as network authentication, e-business, portable electronics products, personal ID cards, security system, and the like.

The method for reading a fingerprint in real-time has become the important issue in the biometrics market. Conventionally, an optical fingerprint sensor may be used to read a fingerprint in real-time. However, the optical fingerprint sensor has some drawbacks like it is large in size and has high power consumption. Consequently, silicon fingerprint sensors, which overcome the drawbacks of the optical sensor and are formed by silicon semiconductor technology, are developed. For example, the capacitive fingerprint sensor with the product model number LTT-C500 available from LIGHTUNING TECH. INC. has the advantage.

Owing to the finger dimension, the sensing area of the conventional silicon fingerprint sensor is large, for example, it is greater than 9 mm*9 mm. Furthermore, owing to the limitations in manufacturing the silicon integrated circuit, only 50 to 70 good dies may be formed in a 6″ wafer. The sensor is expensive to various applications. Thus, this expensive price may restrict the silicon fingerprint sensor in various consumer electronics applications such as notebook computers, mobile phones, personal digital assistants, computer peripheral products, or even personal ID cards embedded with the fingerprint sensor.

In order to overcome the cost problem, it is possible to reduce one-dimensional length of the conventional, two-dimensional (2D) area-type silicon fingerprint sensor to that of the linear sensor structure so as to increase the number of good dies and decrease the price of the sensing device. In this case, the finger sweeps across the sensor surface and the overall finger is sequentially scanned into a plurality of whole fragment images, which are then re-constructed into a complete image.

Mainguet et. al. and Kramer disclose linear fingerprint sensors and methods for reconstructing multiple overlapped whole images into a complete image in U.S. Pat. Nos. 6,289,114 and 6,317,508, as shown in FIGS. 1 and 2. FIG. 1 is a schematic illustration showing the conventional architecture using a linear fingerprint sensor to read images of a fingerprint. The sensor 110 is an array device having a horizontal dimension substantially equal to the width of the finger 120 and a vertical dimensional far smaller than the horizontal dimension, wherein the finger sweeps vertically. Thus, a relative moving speed V between the finger 120 and the sensor 110 is created. That is, the finger 120 sweeps over the surface of the sensor 110 at the speed V. Thus, the sensor 110 can continuously acquire whole fragment images, such as continuous whole fragment images 121a to 121s of FIG. 2A. The continuous whole fragment images 121a to 121s can be outputted to a microprocessor 130 with the data size as shown in FIG. 2B, and then stored in a random access memory (RAM) 140. Thereafter, the microprocessor 130 extracts the continuous fragment images 121a to 121s and reconstructs the fingerprint images according to the software algorithm stored in a read only memory (ROM) 150. First, the images 121a and 121b are reconstructed into an image 121ab, and then the images 121c and 121ab are reconstructed into an image 121abc, as shown in FIG. 2C. The processes are repeated in a similar manner such that the fragment images 121a to 121s are reconstructed into a complete fingerprint image 122 corresponding to the fingerprint, as shown in FIG. 2D.

This method should acquire a relatively large fingerprint image without using a large-area sensor, and is thus advantageous to the cost reduction, and the enhancement of the identification quality, such as the low false access rate and the low false rejection rate, which is similar to that obtained by the large-area fingerprint sensor.

However, the architecture and the method of the sensor 110 have some drawbacks. First, hundreds of fragment images have to be acquired within a very short period of time (smaller than 1 second). For example, if the sweeping speed of the finger is 10 cm/sec and the specification of the fingerprint sensor is 8*280 (this is the specification of “Atmel Fingerchip”, 500 dpi), the random access memory 140 must have the capacity larger than 600 Kbytes or a larger buffer memory is needed for the subsequent reconstructing process, and the cost of the system is thus increased. The '114 patent combines a first combined image, which is formed by combining a first fragment image with a second fragment image, with a third fingerprint image to form a second combined image. Then, the second combined image is combined with a fourth fingerprint image to form a third combined image. In this case, the memory occupied by the combined image gradually increases, and the buffer memory has to be large enough such that all fingerprint images can be combined.

Furthermore, in order to finish the fingerprint identifying processes within one second (the typically allowable period is smaller than two seconds) after the finger sweeps over the chip surface, the communication interface between the chip of the sensor 110 and the microprocessor 130 of the host system must be an interface, such as a parallel interface having the DMA mode or the express serial interface of USB2.0, having a larger bandwidth. Thus, the typical I²C or low-speed SPI or RS232 interface cannot be adopted for transmission, and the flexibility of the design is limited. The micro processor must be, for example, a DSP because the working speed of the micro processor must be very high.

Ericson discloses a fingerprint sensing device containing a memory buffer in U.S. Patent Publication No. 2003/0021495. The advantage of the '495 patent is that the image transmission of the microprocessor of the host system is more flexible. However, the problems in the capacity of the random access memory of the host system and in the transmission of the image data within a very short period of time (shorter than one second) through a broadband interface still cannot be solved. The micro processor must be, for example, a DSP because the working speed of the micro processor must be very high. In addition, the '495 patent does not mention how to solve the problem in the subsequent image processing method.

In the application of computer peripherals, some mouse and keyboard with the fingerprint sensing function have been disclosed in the prior art, wherein the authority of using the computer is determiined by reading and judging the user's fingerprint. The mouse and keyboard use area-type fingerprint sensors each sensing the fingerprint of a stationary finger, and the area-type fingerprint sensor is expensive and occupies a larger space, and is thus disadvantageous to the popularization of the product. With the technology development and the convenience in usage, the computer peripheral device with the wireless function gradually replaces the wired device and becomes the mainstream product in the market. Similarly, integrating the fingerprint identification function in a wireless peripheral device has become an important subject. Heretofore, however, the applicant cannot find any wireless peripheral device body, which is equipped with a fingerprint sensor and transfers the image to the computer device for comparison in a wireless manner. The main problem is that the current sweep-type fingerprint sensor has to transfer a lot of data to the host system such that the user has to wait for several seconds to several tens of seconds (depending on the type of the wireless emitter), and the current technology cannot effectively overcome this problem.

It is therefore an subject of the invention to provide a wireless peripheral device having a device body on which a sweep-type fingerprint sensor is disposed, wherein the device can effectively reduce the transmitted data quantity such that the user can use the fingerprint sensor on the device body in real time and the host system can finish the comparison operation immediately.

### SUMMARY OF THE INVENTION

It is therefore an object of the invention to provide a wireless peripheral device, which has a sweep-type fingerprint sensing chip and outputs non-overlapped fingerprint fragment images to a host system so as to reduce the wireless data transmission quantity.

To achieve the above-identified object, the invention provides a wireless peripheral device having a receiving module, a peripheral device body and a sweep-type fingerprint sensing chip. The receiving module is coupled to a host system through a cable and has a receiver. The peripheral device body communicates with the receiving module in a wireless manner and has an emitter. The fingerprint sensing chip, which is disposed on the peripheral device body, senses and processes a plurality of fingerprint fragment images of a finger as the finger is sweeping over the fingerprint sensing chip substantially along a sweeping direction to generate a plurality of fragment images, which is transmitted to the receiver through the emitter and then to the host system.

In order to speed up the fingerprint sensing process, the fingerprint sensing chip may include a rectangular array sensor, a gain controllable amplifier, an analog/digital converter, an image matching module, an input/output interface and a control logic. The rectangular array sensor senses the plurality of fingerprint fragment images of the finger as the finger is sweeping substantially along the sweeping direction to obtain a plurality of analog fingerprint fragment signals. The gain controllable amplifier amplifies the analog fingerprint fragment signals and then outputs a plurality of amplified signals. The analog/digital converter sequentially receives and converts the amplified signals into a plurality of digital fragment fingerprint signals. The image matching module receives and compares the digital fragment fingerprint signals and sequentially generates the plurality of fragment images, which does not overlap with one another. The input/output interface, which is electrically connected to the emitter of the peripheral device body, sequentially outputs the fragment images to the receiving module. The host system assembles the fragment images into a complete fingerprint image in a manner of stacking the fragment images side by side. The control logic controls operations of the rectangular array sensor, the gain controllable amplifier, the analog/digital converter, the image matching module and the input/output interface.

The image matching module may include a memory, an image matching unit and a memory control unit. The memory temporarily stores adjacent two of the digital fragment fingerprint signals. The image matching unit matches adjacent two of the digital fragment fingerprint signals stored in the memory to generate the fragment images. The memory control unit controls operations of the memory and the image matching unit.

### BRIEF DESCRIPTION OF THE DRAWINGS

FIG. 1 is a schematic illustration showing the architecture of reading a fingerprint image of a finger using a prior art sweep-type fingerprint sensor.

FIGS. 2A to 2D show an example of reconstructing fingerprint fragment images into a complete fingerprint image according to the prior art.

FIG. 3 is a block diagram showing a wireless peripheral device according to a first embodiment of the invention.

FIG. 4 is a schematic illustration showing a fingerprint sensing chip for capturing images according to the invention.

FIG. 5 is a schematic illustration showing that the first fragment image signal and the second fragment image signal of FIG. 4 are being assembled.

FIG. 6 is a schematic illustration showing that the second fragment image signal and the third fragment image signal of FIG. 4 are being assembled.

FIG. 7 is a block diagram showing another sweep-type fingerprint sensing chip according to the first embodiment of the invention.

FIG. 8 is a block diagram showing a wireless peripheral device according to a second embodiment of the invention.

FIG. 9 is a block diagram showing a wireless peripheral device according to a third embodiment of the invention.

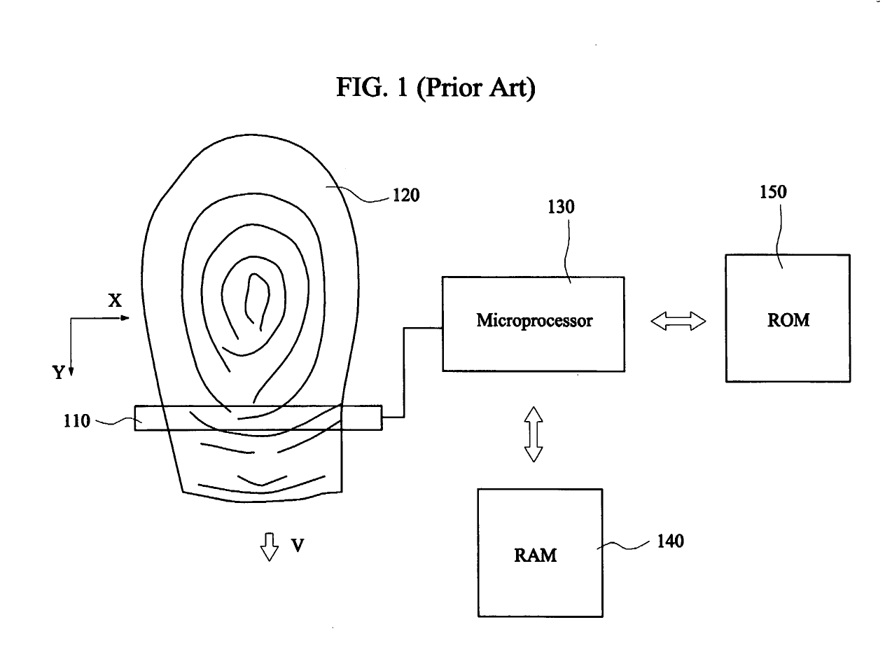

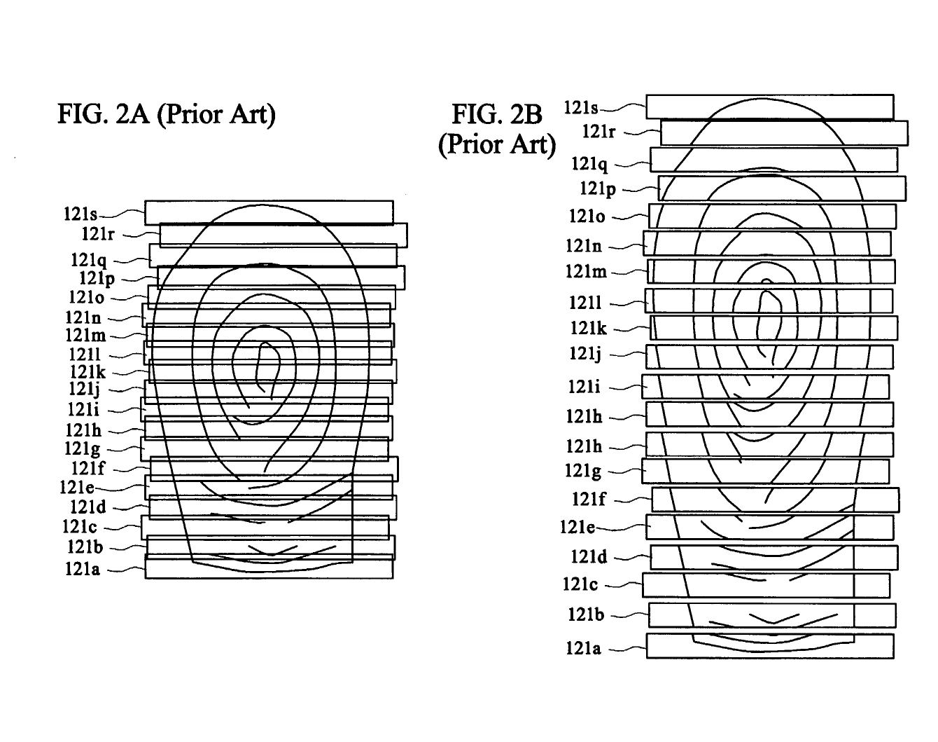

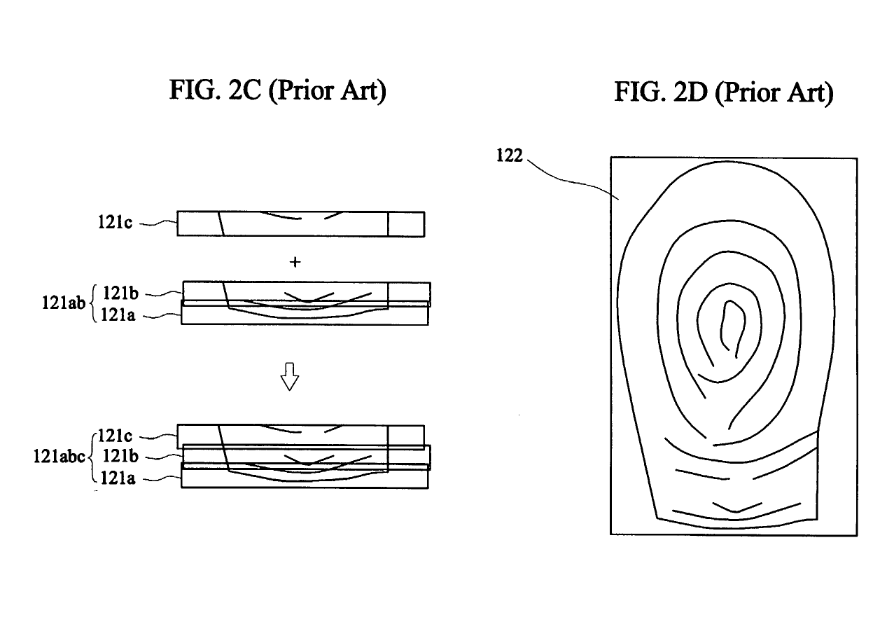

### DETAILED DESCRIPTION OF THE INVENTION

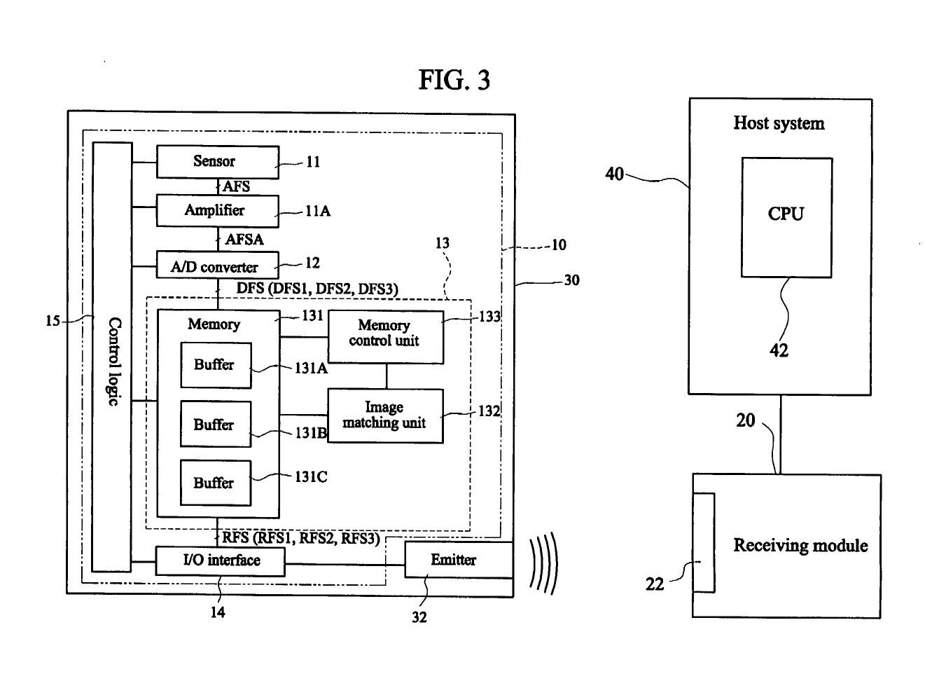

FIG. 3 is a block diagram showing a wireless peripheral device according to a first embodiment of the invention. Referring to FIG. 3, the wireless peripheral device of this embodiment includes a receiving module 20, a peripheral device body 30 and a sweep-type fingerprint sensing chip 10. The receiving module 20 is coupled to a host system 40 through a cable and has a receiver 22, which may be included in a transceiver. For example, the receiving module 20 is coupled to the host system 40 through a universal serial bus (USB) interface, a PCMCIA interface, a PCI express interface or an IEEE 1394 interface. The host system 40 may be, for example, a computer, a mobile phone, a personal digital assistant, or the like. The host system 40 has a CPU (Central Processing Unit) 42 for processing and identifying fingerprint data, and enables at least one application program in the host system or enables the communication between the receiving module 20 and the peripheral device body 30 after the identification passes. In this invention, the peripheral device body may include the above-mentioned sweep-type fingerprint sensor and include other basic functions. For example, the peripheral device body 30 may be a mouse, a keyboard, a memory storage device, a display, a printer or any other device. The main spirit of this invention is to integrate the sweep-type fingerprint sensor in the peripheral device body, so other functions may pertain to the prior art and detailed descriptions thereof will be omitted.

An emitter 32, which communicates with the receiving module 20 in a wireless manner through a wireless network adaptor (802.11 series), or an infrared Ir-Da, or a bluetooth interface, is disposed in the peripheral device body. Thus, the peripheral device body 30 communicates with the receiving module 20 in the wireless manner and has the emitter 32, which may be included in the transceiver. The sweep-type fingerprint sensing chip 10 disposed on the peripheral device body 30 senses and processes a plurality of fingerprint fragment images of a finger as the finger is sweeping over it substantially along a sweeping direction to generate a plurality of fragment images. The fragment images are transmitted to the host system 40 through the emitter 32 and the receiver 22.

In order to reduce the transmitted data quantity, the sweep-type fingerprint sensing chip 10 may include a rectangular array sensor 11, a gain controllable amplifier 11A, an analog/digital converter 12, an image matching module 13, an input/output (I/O) interface 14 and a control logic 15. The rectangular array sensor 11 may be formed on a substrate in advance. In this embodiment, the substrate is made of silicon. The sensor may be a capacitive sensor, a pressure sensor or a thermoelectric sensor, an optical sensor or other type fingerprint sensors as disclosed in the above-mentioned (b) to (e) patents, and detailed descriptions thereof will be omitted.

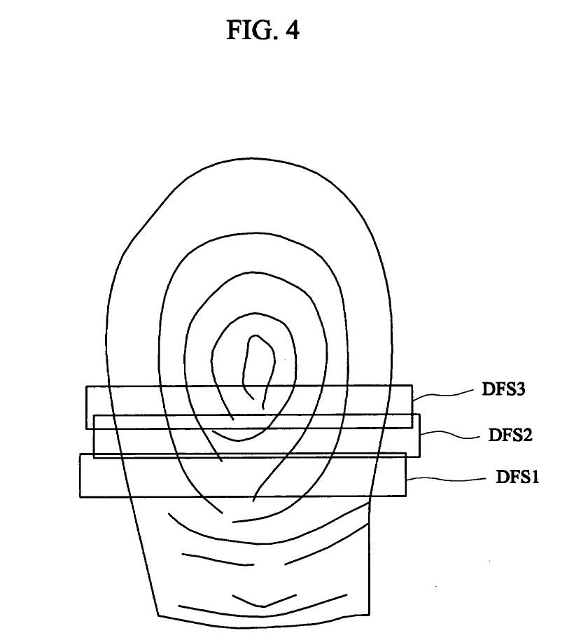

The rectangular array sensor 11 senses the plurality of fingerprint fragment images of the finger as the finger is sweeping over it substantially along the sweeping direction to obtain a plurality of analog fingerprint fragment signals AFS. The gain controllable amplifier 11A properly amplifies the analog fingerprint fragment signals AFS into a plurality of amplified signals AFSA for output. The analog/digital converter 12 sequentially receives and converts the amplified signals AFSA into a plurality of digital fragment fingerprint signals DFS. For the sake of simplification, the digital fragment fingerprint signals DFS at least includes a first fragment image signal DFS1, a second fragment image signal DFS2 and a third fragment image signal DFS3, as shown in FIG. 4.

The image matching module 13 receives and compares the digital fragment fingerprint signals DFS, and sequentially generates a plurality of non-overlapped fragment images RFS. The fragment images RFS include a first fragment image RFS1, a second fragment image RFS2 and a third fragment image RFS3 in order. The input/output interface 14 electrically connected to the emitter 32 of the peripheral device body 30 sequentially outputs the fragment images RFS to the receiving module 20. Because the fragment images RFS do not overlap with one another, the number of pixels of each fragment image RFS in the sweeping direction is smaller than or equal to the number of sensing units of the rectangular array sensor 11 in the sweeping direction.

If the third fragment image RFS3 is the last output signal, the data quantity of any one of the first fragment image RFS1 and the second fragment image RFS2 is smaller than or equal to that of the third fragment image RFS3 because the fragment images RFS do not overlap with one another.

Thus, the host system 40 can combine the fragment images RFS into a complete fingerprint image by stacking and assembling the images side by side for the subsequent identification process. After the identification passes, at least one application program (e.g., the authority of using the computer) in the host system can be enabled or the function of the peripheral device body 30, such as receiving the pointer signal of the mouse or receiving the keyboard signal of the keyboard, can be enabled.

The control logic 15 controls operations of the rectangular array sensor 11, the gain controllable amplifier 11A, the analog/digital converter 12, the image matching module 13 and the input/output interface 14.

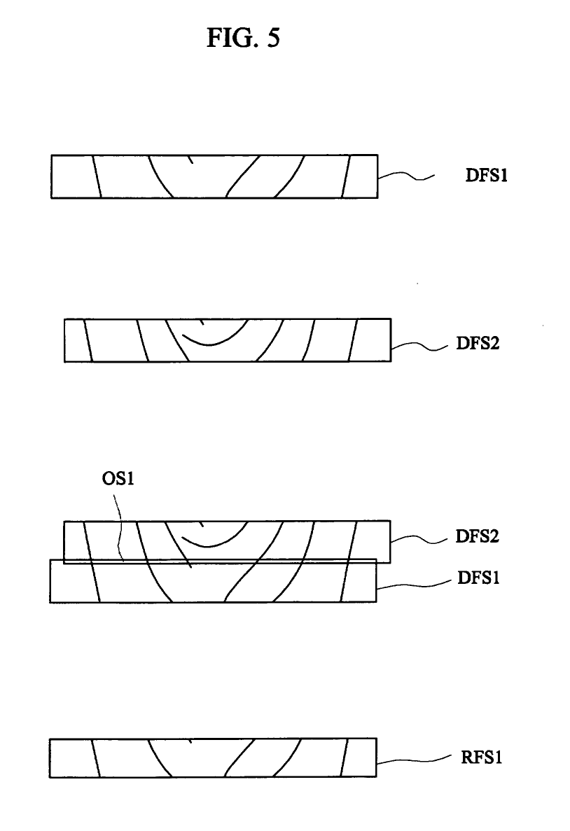

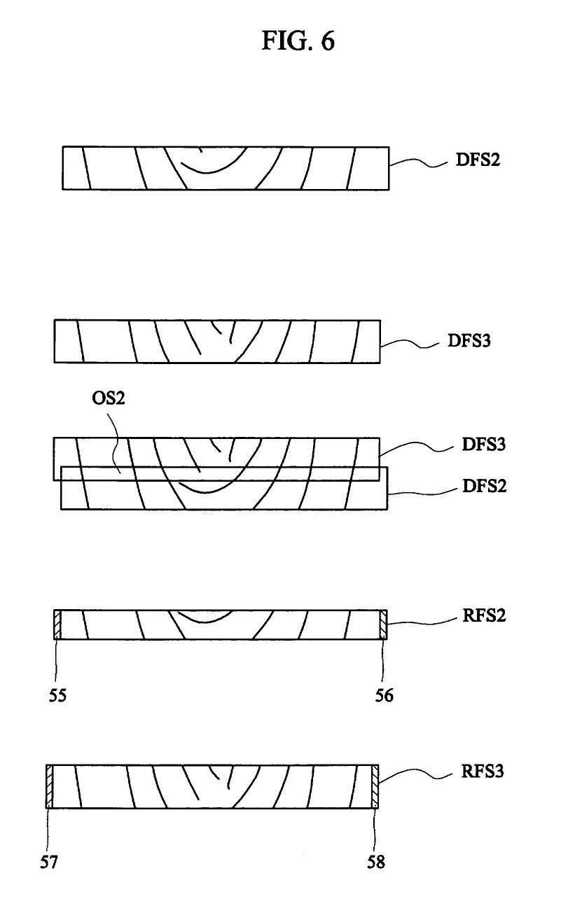

FIG. 4 is a schematic illustration showing a fingerprint sensing chip for capturing images according to the invention. FIG. 5 is a schematic illustration showing that the first fragment image signal and the second fragment image signal of FIG. 4 are being assembled. FIG. 6 is a schematic illustration showing that the second fragment image signal and the third fragment image signal of FIG. 4 are being assembled. As shown in FIGS. 4 to 6, the image matching module 13 has received the first fragment image signal DFS1 and the second fragment image signal DFS2 and then matches the first fragment image signal DFS1 with the second fragment image signal. DFS2 and outputs the assembled result. At this time, the first fragment image RFS1 is a partial image of the first fragment image signal DFS1 exclusive of the overlapped portion between the first fragment image signal DFS1 and the second fragment image signal DFS2. In order to reduce the chip area, the cost and the power consumption of the invention, the operation algorithm of the image matching module, which is an integrated circuit, in this invention must be very simple such that no microprocessor or DSP with the floating point calculation function is needed and only the typical digital logic circuit is needed. Thus, the requirements of the small area, the high speed and the low power consumption may be satisfied. The image matching algorithm in this embodiment of the invention compares the intensity distribution between adjacent two of the images, so only the subtraction is needed, and the digital logic circuit can achieve this subtraction easily.

In order to achieve the function of image assembling, the image matching module 13 includes a memory 131, an image matching unit 132 and a memory control unit 133. The memory 131 can temporarily store adjacent two of the digital fragment fingerprint signals DFS, such as the first fragment image signal DFS1 and the second fragment image signal DFS2 of FIG. 5, or the second fragment image signal DFS2 and the third fragment image signal DFS3 of FIG. 6. The image matching unit 132 compares adjacent two of the digital fragment fingerprint signals DFS stored in the memory 131. The fragment images RFS are generated according to the mathematical algorithm. The memory control unit 133 controls the operation of the memory 131 and the communication with the image matching unit 132.

The invention also provides a processing method used in the fingerprint sensing chip of the invention. The method includes the following steps.

First, a plurality of fingerprint fragment images is sensed as a finger is sweeping to obtain a plurality of analog fingerprint fragment signals AFS. Then, the analog fingerprint fragment signals AFS are properly amplified and then the amplified signals AFSA are outputted. Next, the amplified signals AFSA are sequentially converted into a plurality of digital fragment fingerprint signals DFS. The digital fragment fingerprint signals DFS include a first fragment image signal DFS1, a second fragment image signal DFS2 and a third fragment image signal DFS3 in order. Next, adjacent two of the digital fragment fingerprint signals DFS are compared with each other continuously, and a plurality of non-overlapped fragment images RFS is generated. The fragment images RFS include a first fragment image RFS1, a second fragment image RFS2 and a third fragment image RFS3 in order. These continuous and non-overlapped fragment images RFS can be temporarily stored in the buffer 131C through the memory control unit 133, and then the control logic 15 controls the fragment images RFS to be outputted to the host system 40 through the I/O interface 14. Then, a complete fingerprint image may be formed by stacking the fingerprint fragment images side by side.

The detailed steps of comparing the digital fragment fingerprint signals DFS will be described in the following. First, as shown in FIGS. 5 and 3, the buffers 131A and 131B of the memory 131 respectively receive and store the first fragment image signal DFS1 and the second fragment image signal DFS2. Then, the image matching unit 132 compares the first fragment image signal DFS1 with the second fragment image signal DFS2 to obtain a first overlapped signal OS1. Then, the first overlapped signal OS1 is subtracted from the first fragment image signal DFS1 to obtain and output the first fragment image RFS1. Thus, the first fragment image RFS1 is formed by subtracting the overlapped signal OS1 between the first fragment image signal DFS1 and the second fragment image signal DFS2 from the first fragment image signal DFS1. Then, the control logic 15 outputs the first fragment image RFS1 to the host system 40 through the I/O interface 14.

Next, as shown in FIGS. 6 and 3, the first fragment image signal DFS1 stored in the memory 131 is cleared. Then, the empty buffer (e.g., 131A) of the memory 131 receives and stores the third fragment image signal DFS3. Next, the second fragment image signal DFS2 and the third fragment image signal DFS3 are compared to obtain a second overlapped signal OS2. Then, the second overlapped signal OS2 is subtracted form the second fragment image signal DFS2 to obtain and output the second fragment image RFS2. First, the third fragment image signal DFS3 is resampled and the third fragment image RFS3 is generated and outputted. It is to be noted that although the embodiment is described by taking three fragment image signals and three fragment images as an example, the invention is not particularly restricted thereto. The invention is also suitable for the case including two or more than three sets of the fragment image signals and the fragment images. Because the associated processing steps are similar, detailed descriptions thereof will be omitted.

During the comparing process, it is obtained that the third fragment image signal DFS3 is shifted rightward relative to the first fragment image signal DFS1 according to the summation of the signals DFS1 and the DFS2 and the summation of the signals DFS2 and the DFS3. Thus, the second fragment image RFS2 includes a left block 55 but does not include a right block 56, and the third fragment image RFS3 includes a left block 57 but not include a right block 58.

In order to manage and reduce the capacity of the memory 131 effectively, the time for a series of operations including memory writing, image comparing and matching and the fragment image outputting has to be shorter than the time for the finger to sweep over the sensor. In this embodiment, the time has to be less than 1 ms.

Thus, the memory 131 only has to store two fragment signals. So, the minimum capacity of the memory 131 is substantially two times of the data quantity of the digital fragment fingerprint signal DFS.

Heretofore, the invention chip device can continuously output the fingerprint fragment images according to the image matching unit and the memory control method. When the finger is sweeping over the chip device, the moving information in the X-Y coordinate, like the finger moving on a digital panel, can be obtained by judging the output format (e.g., the length change and the change rate or the width change and the change rate in the blocks 57 and 58) of the continuos fragment images.

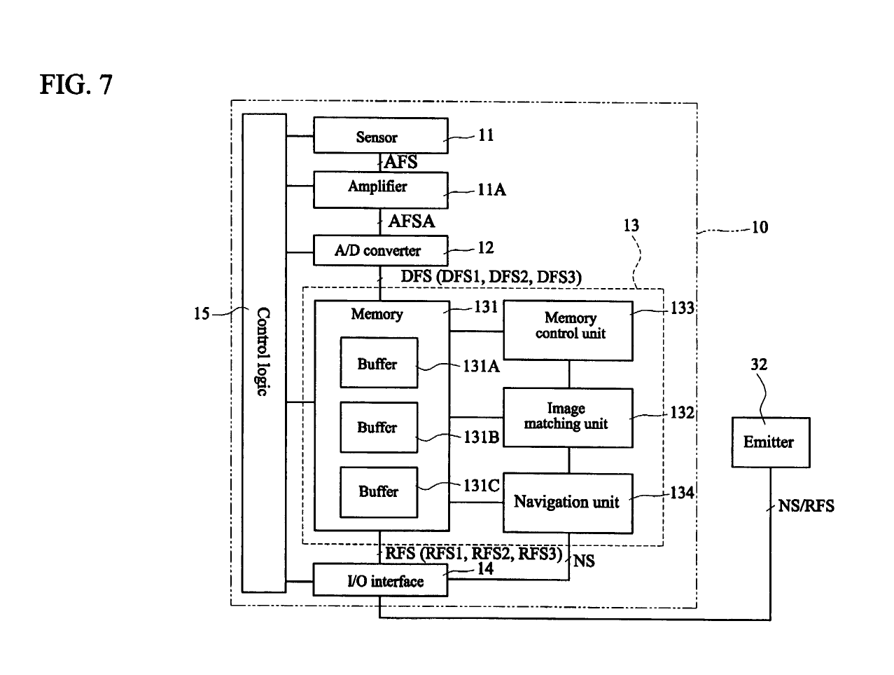

FIG. 7 is a block diagram showing another sweep-type fingerprint sensing chip according to the first embodiment of the invention. As shown in FIG. 7, this embodiment is similar to the first embodiment except that the image matching module 13 further includes a navigation unit 134 controlled by the control logic 15. The navigation unit 134 calculates a relative movement relationship between adjacent two of the digital fragment fingerprint signals DFS according to the fragment images RFS and the digital fragment fingerprint signals DFS so as to output a navigation signal NS through the input/output interface 14 to control a pointer system (e.g., a mouse cursor system) in the host system 40.

It is to be noted that the sweep-type fingerprint sensing chip of this embodiment can provide the function of outputting the navigation signal NS without outputting the fragment images.

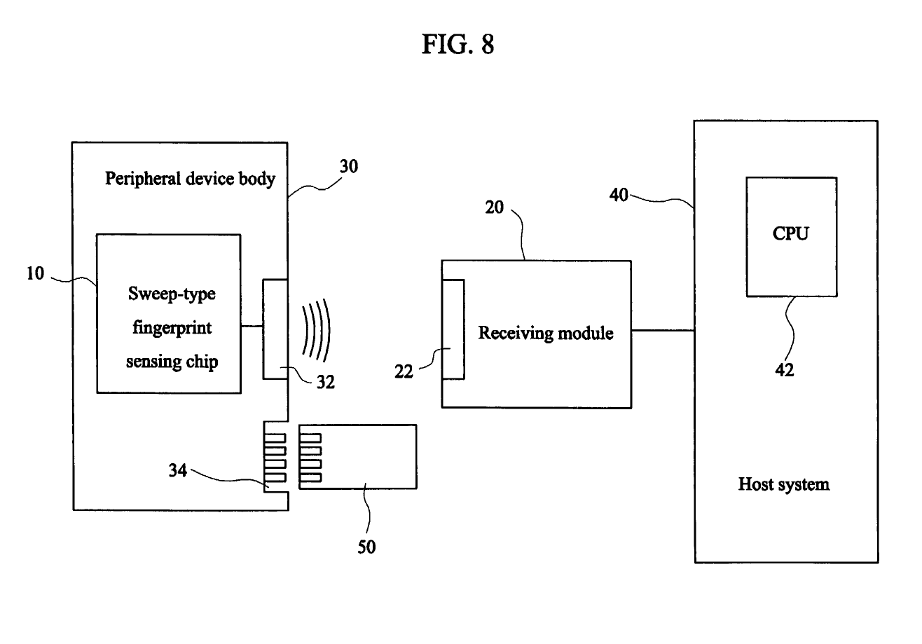

FIG. 8 is a block diagram showing a wireless peripheral device according to a second embodiment of the invention. As shown in FIG. 8, this embodiment is similar to the first embodiment except that the peripheral device body 30 further has an expansion slot 34, into which an external memory or chip card 50 is inserted for connection. In this case, the peripheral device body 30 still may be a mouse, a keyboard, a memory storage device, a display, a printer or any other device.

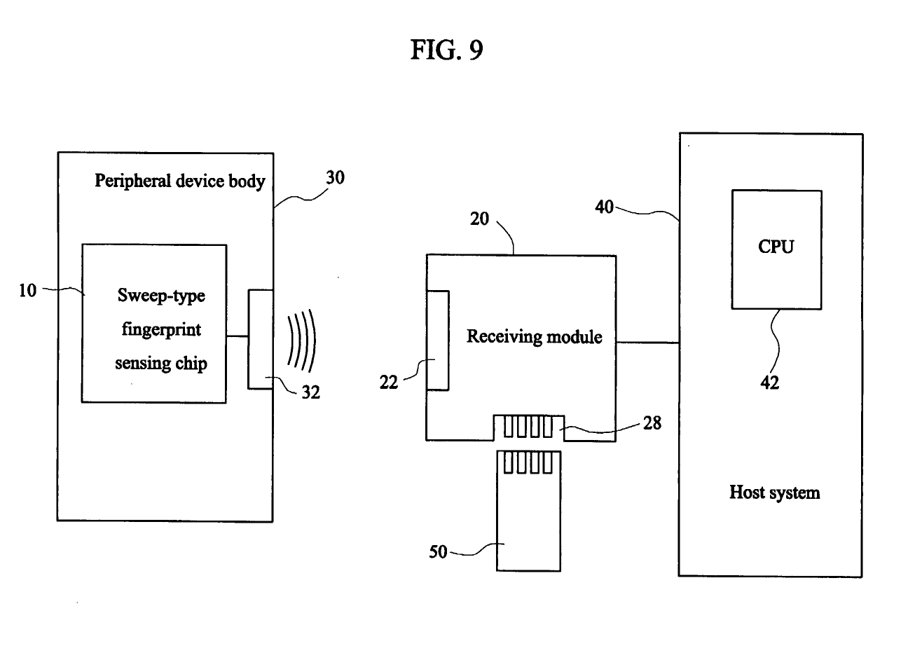

FIG. 9 is a block diagram showing a wireless peripheral device according to a third embodiment of the invention. As shown in FIG. 9, this embodiment is similar to the first embodiment except that the receiving module 20 further has an expansion slot 28, into which an external memory or chip card 50 is inserted for connection. In this embodiment, the external memory or chip card 50 is coupled to the host system 40 through a cable.

According to the embodiment of the invention, when the sweep-type fingerprint sensing chip with the image assembling function is performing the comparing process, the simple logic operation can be used without any complicated processing circuit. Thus, the effect of low power consumption and the product miniaturization can be achieved. In addition, because the minimum capacity of the memory may be equal to two times of the data quantity of each digital fragment fingerprint signal, the cost and the power consumption of the sensing chip can be reduced. In addition, because the transmitted data quantity each time is not greater that the data quantity of one digital fragment fingerprint signal and no overlap image exists, the data quantity transmitted by the sensing chip of the invention is only about 1/10 times of the data quantity of the conventional sweep-type fingerprint sensing chip. Thus, the bandwidth between the chip and the host system does not have to be too high, and the memory space of the host system can be reduced greatly. Due to the technological features, the sweep-type fingerprint sensor can be disposed on the wireless peripheral device body, and the fragment image can easily transmit the data to the host system within one to three seconds in a wireless manner. Thus, the prior art drawbacks can be improved, the application of the invention can be broadened, and the user does not have to wait for the image transmission.

While the invention has been described by way of examples and in terms of preferred embodiments, it is to be understood that the invention is not limited to the disclosed embodiments. To the contrary, it is intended to cover various modifications. Therefore, the scope of the appended claims should be accorded the broadest interpretation so as to encompass all such modifications.

What is claimed is:

1. A wireless peripheral device, comprising:
a receiving module, which is coupled to a host system through a cable and has a receiver;
a peripheral device body, which communicates with the receiving module in a wireless manner and has an emitter; and
a fingerprint sensing chip, which is disposed on the peripheral device body, for sensing and processing a plurality of fingerprint fragment images of a finger as the finger is sweeping over the fingerprint sensing chip substantially along a sweeping direction to generate a plurality of fragment images, which is transmitted to the receiver through the emitter and then to the host system.

2. The device according to claim 1, wherein the fingerprint sensing chip comprises:
a rectangular array sensor for sensing the plurality of fingerprint fragment images of the finger as the finger is sweeping substantially along the sweeping direction to obtain a plurality of analog fingerprint fragment signals;
a gain controllable amplifier for amplifying the analog fingerprint fragment signals and then outputting a plurality of amplified signals;
an analog/digital converter sequentially receiving and converting the amplified signals into a plurality of digital fragment fingerprint signals;
an image matching module for receiving and comparing the digital fragment fingerprint signals and sequentially generating the plurality of fragment images, which does not overlap with one another;
an input/output interface, which is electrically connected to the emitter of the peripheral device body, for sequentially outputting the fragment images to the receiving module, wherein the host system assembles the fragment images into a complete fingerprint image in a manner of stacking the fragment images side by side; and
a control logic for controlling operations of the rectangular array sensor, the gain controllable amplifier, the analog/digital converter, the image matching module and the input/output interface.

3. The device according to claim 2, wherein the number of pixels of each of the fragment images in the sweeping direction is smaller than or equal to the number of sensing units of the rectangular array sensor in the sweeping direction.

4. The device according to claim 2, wherein the fragment images comprise a first fragment image, a second fragment image and a third fragment image in order, and data quantity of any one of the first fragment image and the second fragment image is smaller than or equal to data quantity of the third fragment image.

5. The device according to claim 2, wherein the image matching module comprises:
a memory for temporarily storing adjacent two of the digital fragment fingerprint signals;
an image matching unit for matching adjacent two of the digital fragment fingerprint signals stored in the memory to generate the fragment images; and
a memory control unit for controlling operations of the memory and the image matching unit.

6. The device according to claim 5, wherein a capacity of the memory is substantially equal to two times of data quantity of each of the digital fragment fingerprint signals.

7. The device according to claim 5, wherein the image matching module further comprises a navigation unit, which calculates a relative moving relationship between adjacent two of the digital fragment fingerprint signals according to the fragment images and the digital fragment fingerprint signals and thus outputs, through the input/output interface, a navigation signal to control an operation of an pointer system in the host system.

8. The device according to claim 2, wherein the digital fragment fingerprint signals comprise a first fragment image signal and a second fragment image signal in order, and the fragment images comprise a first fragment image, which is obtained by subtracting an overlapped signal between the first fragment image signal and the second fragment image signal from the first fragment image signal.

9. The device according to claim 2, wherein the receiving module is coupled to the host system through a universal serial bus (USB) interface, a PCMCIA interface, a PCI express interface or an IEEE 1394 interface.

10. The device according to claim 2, wherein the peripheral device body communicates with the receiving module through a wireless network adaptor (802.11A), an Ir-Da or a bluetooth interface.

11. The device according to claim 2, wherein the peripheral device body is a mouse, a keyboard, a memory storage device, a display or a printer.

12. The device according to claim 2, wherein the peripheral device body further has an expansion slot, into which an external memory or a chip card may be inserted for connection.

13. The device according to claim 2, wherein the receiving module further has an expansion slot, into which an external memory or a chip card may be inserted for connection.
